(19) United States
(12) Patent Application Publication
(10) Pub. No.: US 2022/0410923 A1
(43) Pub. Date: Dec. 29, 2022

(54) METHOD FOR COORDINATING VEHICLES OF A GROUP OF VEHICLES DURING EMERGENCY BRAKING, AND CONTROL UNIT

(71) Applicant: ZF CV Systems Europe BV, Brussels (BE)

(72) Inventor: Richard Matthaei, Hameln (DE)

(21) Appl. No.: 17/781,378

(22) PCT Filed: Dec. 1, 2020
(86) PCT No.: PCT/EP2020/084039

§ 371 Date: Jun. 1, 2022

(30) Foreign Application Priority Data
Dec. 4, 2019 (DE) 10 2019 132 943.4

(51) Int. Cl. B60W 50/16; B60W 30/165; B60W 10/18; B60T 7/22

(52) U.S. Cl. CPC B60W 50/16; B60W 30/165; B60W 10/18; B60T 7/22; B60W 2050/048

(57) ABSTRACT

A method for coordinating vehicles of a vehicle group, including implementing a requested setpoint acceleration, wherein the setpoint acceleration for each vehicle is specified as a function of an emergency braking request triggered manually or automatically, assigning a position in the vehicle group to each vehicle, implementing the emergency braking request, providing, in an advanced emergency braking system (AEBS) cascade, at least a first warning phase for an optical or acoustic warning of a driver of the respective vehicle of the vehicle group, and an emergency braking phase for braking the respective vehicle of the vehicle group as a function of the emergency braking request, at an emergency braking time, and providing a haptic warning phase for at least one vehicle of the vehicle group at a haptic time within a framework of the AEBS cascade.

### CROSS REFERENCE TO RELATED APPLICATIONS

This application is a U.S. National Phase application under 35 U.S.C. § 371 of International Application No. PCT/EP2020/084039, filed on Dec. 1, 2020, and claims benefit to German Patent Application No. DE 10 2019 132 943.4, filed on Dec. 4, 20219. The International Application was published in German on Jun. 10, 2021 as WO 2021/110637 A1 under PCT Article 21(2).

### FIELD

The invention relates to a method for coordinating vehicles of a vehicle group during emergency braking, and to a control unit for carrying out the method.

### BACKGROUND

It is known that a plurality of vehicles can move one behind the other in a manner coordinated with one another on a roadway at short actual following distances in order to save fuel by reduced drag and/or to reduce steering times by automation of the function. Vehicles coordinated in this way are also referred to as a vehicle group, vehicle convoy or platoon. In the case of such coordinated driving, the intention is to go below the nowadays customary safety distance between the individual vehicles if the vehicles coordinate with one another, for example via wireless V2X communication. In this case, the individual vehicles of the vehicle group are coordinated, for example, by a lead vehicle, which can communicate with the other vehicles via the wireless V2X communication and can exchange data, in particular driving-dynamics data for or from the respective vehicles. Furthermore, it is also possible for information about the environment, including the surrounding road users which do not belong to the vehicle group, to be exchanged.

In this case, the lead vehicle can, in particular, define a specific setpoint following distance and also a central acceleration request and can communicate via the V2X communication, wherein the individual vehicles of the vehicle group set or implement the setpoint following distance, e.g. via a headway control system, and the central acceleration request as a setpoint acceleration via the drive system and/or the braking system. This makes it possible to ensure that the individual vehicles of the vehicle group can react quickly to one another, thereby avoiding an impairment of safety and thus making it possible to go below the safety distance since the reaction times are shortened. It is also possible for the following vehicles of the vehicle group (in particular for the case of decentralized vehicle group coordination) to define their setpoint following distances and setpoint accelerations themselves on the basis of available driving-dynamics data and, in the process, also to access additional information, which is provided in data signals via the V2X communication.

As a result, it is normally possible to coordinate the vehicle group and to operate the individual vehicles in any desired positive or negative acceleration situation in such a way that, if at all possible, the vehicles within a vehicle group do not collide with one another. For this purpose, the acceleration of the individual vehicles within the vehicle group can additionally be mutually coordinated in such a way that the setpoint acceleration of the individual vehicles is limited to a maximum acceleration. Here, the maximum acceleration depends on the vehicle having the lowest driving capacity or the lowest braking capacity within the vehicle group. This ensures that the vehicles in front of the vehicle with the lowest braking capacity do not decelerate faster, or the vehicles behind the vehicle with the lowest driving capacity do not accelerate positively more quickly, and a collision is thereby avoided. However, the problem is that it is often not known within the vehicle group how high the maximum driving capacity or the maximum braking capacity of the individual vehicles is and how fast this can be achieved.

Furthermore, it is known that a vehicle having a predictive emergency braking system (AEBS, Advanced Emergency Braking System) is braked in a so-called AEBS cascade. In this context, for example, according to DE 10 2008 045 481 Al, after an emergency braking situation has been detected, first of all a warning phase for the optical and/or acoustic warning of the driver, a haptic braking phase, in which the vehicle is decelerated with a specific setpoint jerk along a specified partial braking ramp from a specific time, and an emergency braking phase for braking the respective vehicle as a function of the specified emergency braking request are provided.

### SUMMARY

In an embodiment, the present disclosure provides a method for coordinating vehicles of a vehicle group, wherein the vehicles each have an electronically controllable braking system, the method comprising implementing a requested setpoint acceleration, taking into account a setpoint jerk, via the electronically controllable braking system, wherein the setpoint acceleration for each vehicle is specified as a function of an emergency braking request triggered manually or automatically, assigning a position in the vehicle group to each vehicle, implementing the emergency braking request, providing, in order to implement the emergency braking request in a respective vehicle of the vehicle group, in an advanced emergency braking system (AEBS) cascade, at least a first warning phase for an optical or acoustic warning of a driver of the respective vehicle of the vehicle group, and an emergency braking phase for braking the respective vehicle of the vehicle group as a function of the emergency braking request, taking into account the setpoint jerk, at an emergency braking time, and providing a haptic warning phase for at least one vehicle of the vehicle group at a haptic time within a framework of the AEBS cascade, wherein in the haptic warning phase, the respective vehicle is decelerated continuously with a defined intermediate acceleration which is less than a haptic limit of the emergency braking request, wherein the haptic time for initiating the haptic warning phase or the setpoint jerk for implementing the emergency braking request in the emergency braking phase is defined in a vehicle-specific manner.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a vehicle group comprising three vehicles;

FIGS. 2a, 2b, and 2c show illustrative AEBS cascades during an emergency braking situation; and

FIG. 3 shows a flow diagram of the method according to an embodiment of the invention.

### DETAILED DESCRIPTION

In an embodiment of the invention, a method for coordinating vehicles in a vehicle group is specified by means of which safe driving operation within the vehicle group can be ensured, even in the case of emergency braking. In some embodiments, a control unit and a vehicle are also specified.

Accordingly, a method is provided for coordinating vehicles of a vehicle group during emergency braking or during the presence of an emergency braking request, wherein the vehicles each have an electronically controllable braking system for implementing a requested setpoint acceleration, taking into account a setpoint jerk, and a position in the vehicle group is assigned to each vehicle, wherein the setpoint acceleration for the respective vehicle is specified as a function of a central emergency braking request, triggered manually or in an automated manner, of an emergency braking system. In order to implement the emergency braking request in the respective vehicle of the vehicle group, in an AEBS cascade, at least

a first warning phase for the optical and/or acoustic warning of the driver of the respective vehicle of the vehicle group, and

an emergency braking phase is provided for braking the respective vehicle as a function of the emergency braking request, taking into account the setpoint jerk, at an emergency braking time assigned to the respective vehicle,

wherein a haptic warning phase is provided for at least one vehicle of the vehicle group at a haptic time associated with the respective vehicle within the framework of the AEBS cascade, which warning phase is, in particular, between the first warning phase and the emergency braking phase, and in which the respective vehicle is decelerated continuously with a defined intermediate acceleration, which is less than the emergency braking request.

According to an embodiment of the invention, provision is made here for the haptic time for initiating the haptic warning phase and/or the setpoint jerk for implementing the emergency braking request in the emergency braking phase to be defined in a vehicle-specific manner.

The AEBS cascade of a predictive emergency braking system or AEBS (Autonomous/Advanced Emergency Braking System), which is prescribed by law and for reasons of monitoring ability, is normally required in each of the vehicles in order, on the one hand, to allow overriding by the driver of the leading vehicle (lead vehicle) of the vehicle group in the event of incorrect detection and, on the other hand, to ensure a reaction time for the following traffic.

The AEBS cascade developed according to the prior art is usually composed of

a first warning phase, in which the driver is warned optically and/or acoustically of the emergency braking situation,

a haptic warning phase with active and continuous braking intervention, in which, in addition to the escalation of the warning directed at the driver, the respective vehicle is already being decelerated, from a certain haptic time, by continuous partial braking with a specified intermediate deceleration, in particular a haptic limit, and

the emergency braking phase for braking the respective vehicle as a function of the emergency braking request, taking into account the setpoint jerk.

By means of this AEBS cascade, both the driver of the respective vehicle and the following traffic can be prepared for a subsequent braking situation. They can then react accordingly.

As part of the method according to an embodiment of the invention, this AEBS cascade can be adapted as described below for use in a vehicle group:

the optical or acoustic warning in the first warning phase is output, as before, to the driver of the leading vehicle (lead vehicle) of the vehicle group.

the haptic warning, including the continuous partial braking with the specified intermediate deceleration (haptic warning phase), takes place at a later haptic time or not at all for the leading vehicle. The duration of the haptic warning phase can therefore be reduced to Os for the lead vehicle, or the haptic time for the lead vehicle can be delayed until the emergency braking time, i.e. the beginning of the emergency braking phase, with the effect that the haptic warning phase may possibly be omitted or shortened considerably.

Optionally or additionally, provision can be made for a short haptic braking jerk, i.e. short pulse-like braking, to be given to the driver as a second (haptic) warning stage at an initial time for the lead vehicle, and for the continuous partial braking with the specified intermediate deceleration (haptic warning phase) to be shifted to a later haptic time or to be omitted altogether.

Finally, the emergency braking phase with the maximum braking capacity is initiated in the leading vehicle, taking into account a setpoint jerk.

In the case of an AEBS cascade adapted in this way too, the ability for overriding by the human driver can be made possible for the leading vehicle or lead vehicle and should therefore continue to contain a second warning stage with the aim of warning the driver, e.g. in the form of an acoustic escalation or a short but clearly perceptible braking jerk at the initial time as a substitute for the continuous partial braking, which is delayed or eliminated according to an embodiment of the invention, in the haptic warning phase. The reaction time for the following vehicle within the vehicle group is largely irrelevant for the assessment of monitoring ability since the individual vehicles within the vehicle group automatically coordinate with one another. Therefore, a haptic warning phase with continuous partial braking is less relevant for the leading vehicle and its duration can be reduced as desired (at the expense of a longer emergency braking phase).

The normal AEBS cascade (first warning phase, haptic warning phase with partial braking of e.g. −4 m/s² at a given time, emergency braking phase with the maximum braking capacity, taking into account the setpoint jerk) is implemented only for the last vehicle (tail vehicle) in the vehicle group in order to continue to ensure the possibility of monitoring or the reaction time for the following traffic, which is normally not coordinated with the vehicle group. By virtue of the haptic warning phase, the vehicles following the vehicle group can thus be readied for a possible braking operation of the tail vehicle or of the entire vehicle group in an emergency braking situation.

Expansion or equalization of the vehicle group can thereby be achieved while simultaneously maintaining the AEBS cascade. For this purpose, provision can be made, for example, for the haptic time for initiating the haptic warning phase and/or the setpoint jerk for implementing the emergency braking request in the emergency braking phase of the respective vehicle to be defined as a function of the position of the respective vehicle within the vehicle group. Accordingly, expansion can be achieved in a flexible manner by position-related definition of the behavior in the haptic warning phase and in the emergency braking phase, while at the same time preparing the following traffic for braking.

For this purpose, provision can be made, in particular, for the haptic time for initiating the haptic warning phase to decrease as the position in the vehicle group rises and/or for the setpoint jerk for implementing the emergency braking request in the emergency braking phase of the respective vehicle to become shallower as the position in the vehicle group rises, i.e. for a setpoint jerk which decreases as the position rises to be specified. In this case, the lowest position is assigned to the front vehicle or lead vehicle. The further to the rear a vehicle is traveling in the vehicle group (rising position), the shorter is the haptic time (decreasing) or the earlier the haptic time is set for this vehicle and/or the lower is the selected value for the setpoint jerk. This adaptation is possible within the vehicle group since the vehicles communicate with one another wirelessly. Therefore, expansion can be provided in a selective manner by setting or adapting the haptic time or the setpoint jerk.

Provision can furthermore preferably be made for the setpoint jerk for implementing the emergency braking request in the emergency braking phase of the respective vehicle and/or the emergency braking time to be defined as a function of an actual following distance between the relevant vehicles of the vehicle group. Accordingly, it is advantageously possible to make use of further parameters which are available within the vehicle group, e.g. via wireless data communication. It is thereby advantageously possible to take into account that a distance reserve has possibly been built up within the haptic warning phase, whereupon the emergency braking phase for a specific vehicle can be initiated earlier and with a steeper ramp. Emergency braking can thereby be made safer.

Moreover, provision can preferably be made for the emergency braking time for the respective vehicle to be defined as a function of the haptic time and/or the position of the respective vehicle within the vehicle group. It is thereby likewise possible to take into account whether and when the respective vehicle is already braked in the haptic warning phase and has thereby built up a distance reserve. On the basis of this and also the position of the respective vehicle, it is then advantageously possible to assess whether the emergency braking phase can already be initiated at an earlier time and/or with a different setpoint jerk.

In order to achieve a greater “distance reserve” within the vehicle group in emergency braking situations triggered by the predictive AEBS (Advanced Emergency Braking System), provision can be made to increase the actual distances slowly already in the first warning phase of the AEBS cascade, e.g. on account of the expected false alarm rates, in an energy- and wear-efficient manner by limiting the engine torques of the individual vehicles by corresponding control of the drive system. This slow increase in the actual distance causes a slow change in the actual vehicle dynamics of the individual vehicles, this change being readily implementable by each of the vehicles of the vehicle group.

In the event of incorrect triggering of the AEBS, the driver in the lead vehicle has the possibility, during the entire AEBS cascade, of terminating the triggered emergency braking operation, e.g. by actuating the accelerator pedal (driver override). In this case, the braking interventions in the vehicle group must be released from the front to the rear, i.e. in the reverse order to entry into the AEBS cascade and advantageously by means of a braking ramp, in order to rule out collisions within the vehicle group after the manual driver intervention to terminate the AEBS cascade and in order subsequently to allow superimposed headway control.

Moreover, provision is preferably made for at least the following steps to be carried out:

implementing the emergency braking request in each vehicle of the vehicle group by electric control of the braking system of the respective vehicle, taking into account the setpoint jerk and specified vehicle-specific acceleration parameters, wherein the acceleration parameters define how the requested emergency braking request is implemented;

observing actual driving dynamics of the vehicles of the vehicle group during the implementation of the emergency braking request, taking into account the setpoint jerk and the vehicle-specific acceleration parameters;

assessing the observed actual driving dynamics of the vehicles on the basis of the requested setpoint acceleration for the respective vehicle, taking into account the setpoint jerk and the vehicle-specific acceleration parameters, and outputting a vehicle-specific assessment result;

determining and outputting an acceleration limit value and/or a jerk limit value as a function of the vehicle-specific assessment result and adapting the vehicle-specific acceleration parameters in at least one of the vehicles of the vehicle group as a function of the determined acceleration limit value and/or jerk limit value in order to implement the emergency braking request, taking into account the adapted vehicle-specific acceleration parameters.

In this context, the term vehicle-specific is understood to mean that a parameter set of acceleration parameters or an assessment result is assigned to each vehicle. This advantageously ensures that a check is made individually for each vehicle as to whether it is capable of implementing the requested setpoint acceleration or the emergency braking request, taking into account the setpoint jerk. For this purpose, the maximum braking capacity and/or the maximum driving capacity of the respective vehicle is taken into account by observation and assessment in situ, and therefore this does not necessarily have to be determined in advance, while safe driving operation can nevertheless be ensured. On the other hand, in the event of a change in the vehicle group, for example, an already available parameter set of acceleration parameters can be used as initialization. By means of the acceleration parameters, it is furthermore possible to define in a vehicle-specific manner how the driving dynamics of the respective vehicle are to be adapted in the direction of the requested setpoint acceleration or the emergency braking request in order to avoid the vehicles driving into one another during observation and assessment.

Thus, the method makes it possible, particularly in driving-dynamics limit situations or in the emergency braking situation under consideration, to avoid follow-on accidents in the vehicle group and, at the same time, also to brake the vehicle group as quickly as possible.

Here, provision is preferably made for the assessment of the observed actual driving dynamics to include a comparison of the actual driving dynamics with setpoint driving dynamics for the respective vehicle in order to determine whether the respective vehicle is capable of achieving the setpoint driving dynamics, wherein the setpoint driving dynamics are preferably indicated by the emergency braking request, taking into account the setpoint jerk and the acceleration parameters. In this way, there is the possibility of a simple in situ setpoint-actual comparison, from which it it is possible to deduce directly whether the respective vehicle is capable of implementing the emergency braking request.

Provision is furthermore preferably made for a starting acceleration for defining an initial intermediate acceleration of the respective vehicle in the haptic warning phase and/or a starting jerk for adapting the intermediate acceleration in the direction of the requested emergency braking request in the emergency braking phase to be specified as the vehicle-specific acceleration parameter in order to implement the requested emergency braking request, taking into account the acceleration parameters. In this way, the respective vehicles can advantageously be prescribed starting driving dynamics which each vehicle is preferably capable of performing with a high degree of probability. On this basis, with the starting acceleration gradient or the starting jerk as the setpoint acceleration gradient or setpoint jerk, it is possible to define in a vehicle-specific manner how the respective vehicle is to be accelerated in order to achieve the setpoint acceleration, thus making it is possible to continuously check for each vehicle whether the maximum driving capacity or braking capacity has been achieved.

Provision is furthermore preferably made for a maximum acceleration and/or a maximum jerk to be defined as the acceleration parameter in order to limit a currently requested intermediate acceleration and/or the setpoint jerk, at least when implementing the requested emergency braking request, taking into account the vehicle-specific acceleration parameters in the emergency braking phase. Accordingly, the respective vehicles can be prescribed a limitation, in particular for the emergency braking phase, which can be specified or adapted for optimum coordination of the entire vehicle group, for example as a function of the maximum driving capacity and/or of the maximum braking capacity of one of the vehicles in the vehicle group.

Preferably, this maximum acceleration or this maximum jerk is defined in such a way that it corresponds to the maximum braking capacity of the vehicle with the poorest braking. This is advantageously characterized by the acceleration and/or jerk limit values determined in the method, thus enabling the maximum acceleration or the maximum jerk preferably to be defined and/or adapted as a function thereof.

Here, provision can preferably be made for the maximum acceleration to be adapted as a function of the determined acceleration limit value and/or for the maximum jerk to be adapted as a function of the determined jerk limit value only for those vehicles of the vehicle group which, when the emergency braking request is specified, are traveling ahead of the vehicle assigned to the acceleration limit value and/or the jerk limit value. As a result, the acceleration or jerk is advantageously limited only for those vehicles in the vehicle group which without the limitation would collide with one of the vehicles in the vehicle group.

Provision is furthermore preferably made for the starting jerk of the respective vehicle also to be defined as a function of the position of the vehicle within the vehicle group, wherein the starting jerk of the respective vehicle decreases as the position within the vehicle group rises, wherein the position of the first vehicle of the vehicle group is lower than the position of the last vehicle of the vehicle group. This ensures that not every vehicle has to be braked to the same extent starting from the starting acceleration or the haptic limit in the emergency braking phase.

As a result, the vehicles can advantageously be braked with different driving dynamics from one another during the observation and assessment phase, and thus, with appropriate true-to-position selection of the setpoint jerk, the vehicles can be prevented from running into one another during emergency braking. This is advantageously achieved by virtue of the fact that, in the event of an emergency braking request, a starting jerk of lower value (and of higher magnitude) is set for the last vehicle, this corresponding to a ramp which is steeper in terms of its magnitude and thus to a greater change in the deceleration (negative acceleration) in the direction of the emergency braking request. Thus, the last vehicle with the higher position is braked with the setpoint jerk which is the smallest (or largest in terms of magnitude), thus ensuring that it cannot run into the vehicles traveling ahead, which are braked with a setpoint jerk which is larger (or smaller in terms of magnitude). This applies successively to all the other vehicles in a similar way.

Provision is furthermore preferably made for the observation of the actual driving dynamics to include the observation with respect to time of an actual vehicle speed of the respective vehicle and/or of an actual acceleration of the respective vehicle and/or of an actual jerk of the respective vehicle, taking into account a response time and/or an actual distance between two vehicles of the vehicle group and/or an actual distance change of the actual distance between two vehicles of the vehicle group.

Here, the response time indicates how quickly the braking system of the respective vehicle reacts to an acceleration request, this being dependent, for example, on a time for pressure buildup, etc. This makes it easy to determine whether or not the respective vehicle can achieve the setpoint acceleration or the emergency braking request with the setpoint jerk, taking into account the acceleration parameters.

The assessment of the actual distance or the actual distance change is advantageous particularly in slip situations, i.e. in the case of a braking intervention or a drive intervention, since the measurement or estimation of the actual vehicle speed or of the actual acceleration under the influence of slip (brake slip, drive slip) is subject to errors and can therefore only be of indirect use to the actual safety objective of collision avoidance. The actual distance and the actual distance change, on the other hand, are directly related to a potential risk of collision and can therefore be useful for the safety objective in slip situations too. The actual vehicle speed or the actual acceleration can nevertheless preferably be used for plausibility checking and/or outside of strong braking interventions or drive interventions.

Provision is furthermore preferably made for the vehicle-specific assessment result with regard to the question of whether the respective vehicle changes its actual driving dynamics in accordance with the acceleration parameters to be formed according to whether

the actual vehicle speed of the respective vehicle remains constant, and/or

the actual acceleration of the respective vehicle remains constant or decreases in magnitude within a specified period of time, wherein the specified period of time is dependent on the setpoint jerk, taking into account the response time, and/or

the actual distance between two vehicles remains constant or decreases, and/or

the actual distance change is less than or equal to zero.

Provision is furthermore preferably made for the setpoint acceleration and/or the setpoint jerk and/or the vehicle-specific acceleration parameters for the respective vehicle to be defined in a decentralized manner in the respective vehicles, as a function of data signals transmitted wirelessly between the vehicles, or centrally in one of the vehicles. The method can thus be used in a vehicle group which coordinates itself centrally, for example starting from a lead vehicle, or uses decentralized coordination, in which the respective vehicles themselves define and adapt their driving dynamics as a function of exchanged data signals.

In addition, it is possible to envisage that, during the implementation of the emergency braking request, a check is made, taking into account the setpoint jerk and the vehicle-specific acceleration parameters, to determine whether the actual distance between the individual vehicles of the vehicle group falls below a specified setpoint distance for the respective vehicles. Accordingly, headway control can be superimposed on the method in order, in addition to the optimized setting of the setpoint acceleration, to avoid vehicles running into each other in case of need and thus to make the method more reliable.

A control unit for a vehicle which is located in a vehicle group is furthermore provided, in which, in particular, it is possible to carry out the method according to an embodiment of the invention, wherein the control unit is designed to implement the emergency braking request as the setpoint acceleration in the respective vehicle of the vehicle group by electric control of the braking system of the respective vehicle, wherein the setpoint acceleration for the respective vehicle can be specified as a function of an emergency braking request triggered manually or in an automated manner,

wherein the control unit is designed, in an AEBS cascade,

to request an optical and/or acoustic warning to the driver of the respective vehicle of the vehicle group in a first warning phase, and

to implement braking of the respective vehicle of the vehicle group as a function of the emergency braking request in an emergency braking phase, taking into account the setpoint jerk, at an emergency braking time,

wherein the control unit can implement a haptic warning phase for at least one vehicle of the vehicle group at a haptic time within the framework of the AEBS cascade, in which phase the respective vehicle can be decelerated continuously with a defined intermediate acceleration, which is less than the emergency braking request. According to an embodiment of the invention, provision is made for the control unit to be designed to define the haptic time for initiating the haptic warning phase and/or the setpoint jerk for implementing the emergency braking request in the emergency braking phase in a vehicle-specific manner.

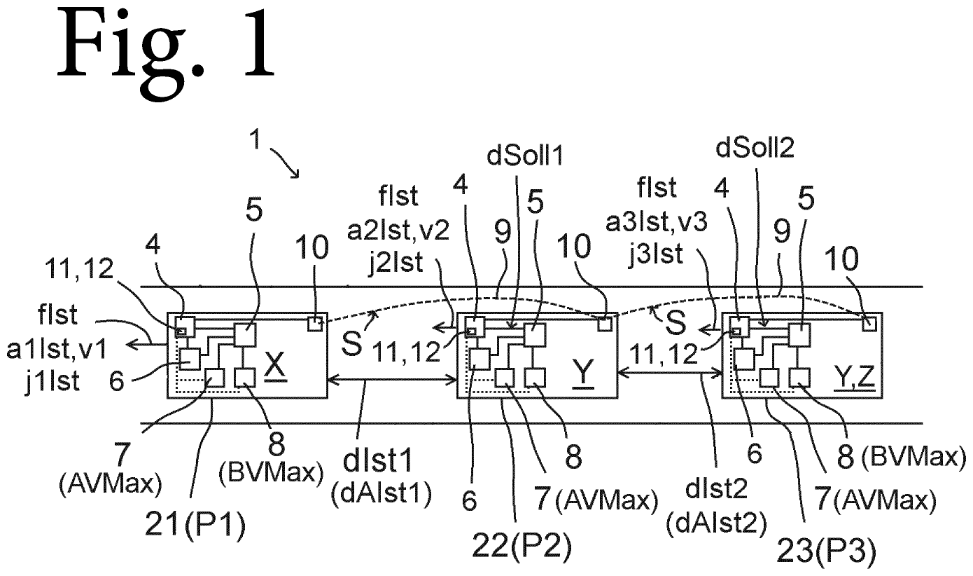

FIG. 1 illustrates a vehicle group 1 or platoon of three vehicles 2i, where i=1, 2, 3, which move at a specific actual following distance dIstj, where j=1, 2, with respect to one another. The first vehicle 21 of the vehicle group 1 is referred to as the lead vehicle X, while the second vehicle 22 and the third vehicle 23 are following vehicles Y of the vehicle group 100. The third vehicle 23, as the last vehicle of the vehicle group 1, is referred to as the tail vehicle Z.

The actual following distances dIstj can be set in such a way during normal driving operation of the vehicle group 1 that they fall below the safety distance between the individual vehicles 2i which is customary nowadays. This can be justified by the fact that the individual vehicles 2i communicate with one another by wireless data communication 9, in particular V2X communication, and thereby coordinate their driving with one another. In the context of embodiments of the invention, V2X communication (vehicle-to-everything) refers to a wireless communication facility which allows the individual vehicles 2i to provide and receive data signals S via a specific interface or in accordance with a specific protocol in order to coordinate themselves. In this case, the data signals S contain, for example, information or data relating to driving-dynamic properties of the individual vehicles 2i and/or relevant information or data relating to the vehicle group 1.

For this purpose, in each of the vehicles 2i there is arranged a V2X unit 10 which, in a conventional manner, has a transmitting and receiving module, via which the data signals S can be transmitted and received. Depending on the exchanged data signals S, the driving dynamics of the individual vehicles 2i in the vehicle group 1 can subsequently be adapted. For this purpose, for example, a setpoint acceleration aiSoll is specified as a function of the data signals S and implemented in the respective vehicle 2i. In this case, the setpoint acceleration aiSoll is implemented in the respective vehicle 2i taking into account a setpoint jerk jiSoll, i.e. a gradient of the setpoint acceleration aiSoll.

In the exemplary embodiment shown, each vehicle 2i has a headway control system 5, which is designed to detect the actual following distance dIstj that is currently present as a function of data from an internal environment detection system 6 and to adjust it to a specified setpoint following distance dSollj, this being relevant only for the following vehicles 22, 23 (Y) in the vehicle group 1 shown. For this purpose, the headway control system 5 is connected in a signal-conducting manner to an electrically controllable drive system 7 and an electrically controllable braking system 8 in order to be able to accelerate or decelerate the respective vehicle 2i in a positive manner and thus set the specified setpoint following distance dSollj.

In normal operation of the vehicle group 1, the setpoint following distance dSollj is specified by means of a control unit 4 in the respective vehicle 2i. The control unit 4 is connected in a signal-conducting manner to the V2X unit 10 or is integrated therein and can therefore access the information and data from the data signal S. As a function of the data signal S, the setpoint following distance dSollj which is matched to the current driving situation of the vehicle group 1, is specified by the control unit 4. The setpoint following distance dSollj can, for example, be determined or defined centrally and transmitted to the individual vehicles 2i of the vehicle group 1 in the data signal S via the wireless data communication 9. The control unit 4 then merely forwards the setpoint following distance dSollj within the vehicle 2i. However, the control unit 4 can also derive the setpoint following distance dSollj itself (in a decentralized manner) for its own vehicle 2i on the basis of the information and data transmitted via the data signal S.

The setpoint following distance dSollj is then transmitted from the control unit 4 to the headway control system 5. The headway control system 5 then generates a setpoint acceleration aiSoll as a function of the determined setpoint following distance dSollj and of the actual following distance dIstj which is currently present, which setpoint acceleration aiSoll is correspondingly implemented via the drive system 7 or the braking system 8 of the respective vehicle 2i with a specific setpoint jerk jiSoll. The setpoint acceleration aiSoll is thus determined in the headway control system 5 as a function of the data signal S or the information and data contained therein.

In this context, it is not only possible for a setpoint acceleration aiSoll for the respective vehicle 2i to be specified by the headway control system 5. On the contrary, it is also possible for the setpoint acceleration aiSoll to be defined or output directly by the control unit 4 and/or by further driver assistance systems 11 in the respective vehicle 2i, which then control the drive system 7 or the braking system 8 electrically, indirectly or directly, as a function thereof in order to implement the setpoint acceleration aiSoll in the vehicle 2i. It is also possible for a centrally defined setpoint acceleration aiSoll to be transmitted to the respective vehicle 2i via the wireless data communication 9 and output by the control unit 4 directly or indirectly, for example via the headway control system 5, to the drive system 7 or the braking system 8.

By way of example, when a dangerous situation is detected, for example by a predictive emergency braking system 12 (AEBS, Advanced Emergency Braking System), one of the vehicles 2i of the vehicle group 1 can generate an emergency braking request zNSoll for implementation in all the vehicles 2i of the vehicle group 1. This emergency braking request zNSoll is transmitted as a (negative) setpoint acceleration aiSoll via the wireless data communication 9 to the individual vehicles 2i of the vehicle group 1 and is received therein by the respective control unit 4 and transmitted to the braking system 8 for implementation.

In the same way, it is also possible in principle for other central acceleration requests aIN for implementation in all vehicles 2i of the vehicle group 1 to be transmitted to the individual vehicles 2i as a setpoint acceleration aiSoll.

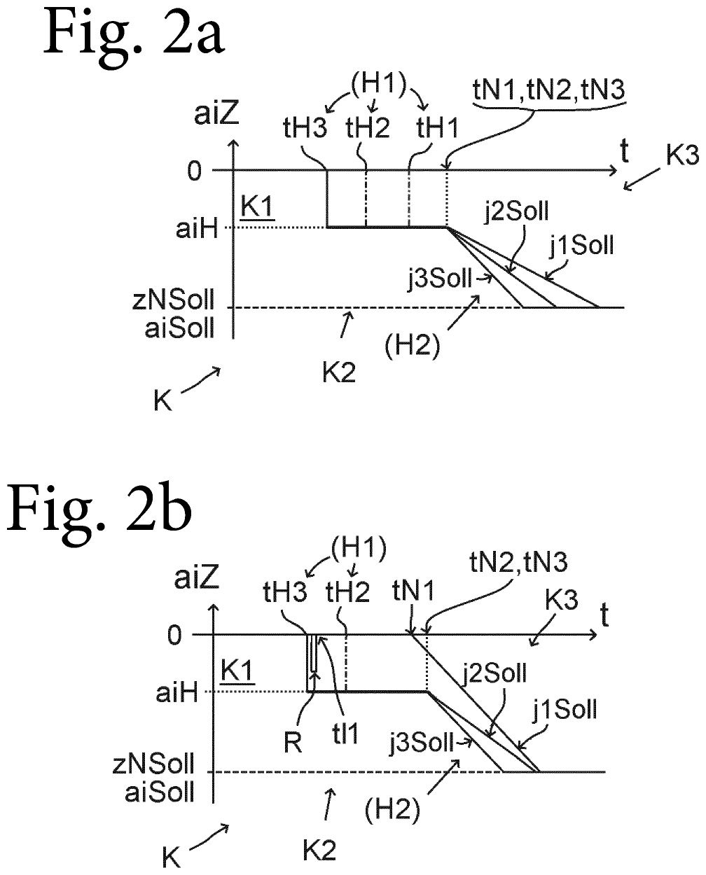

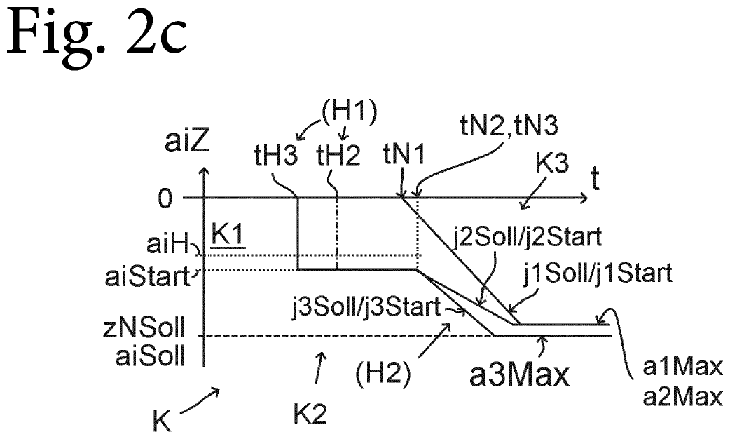

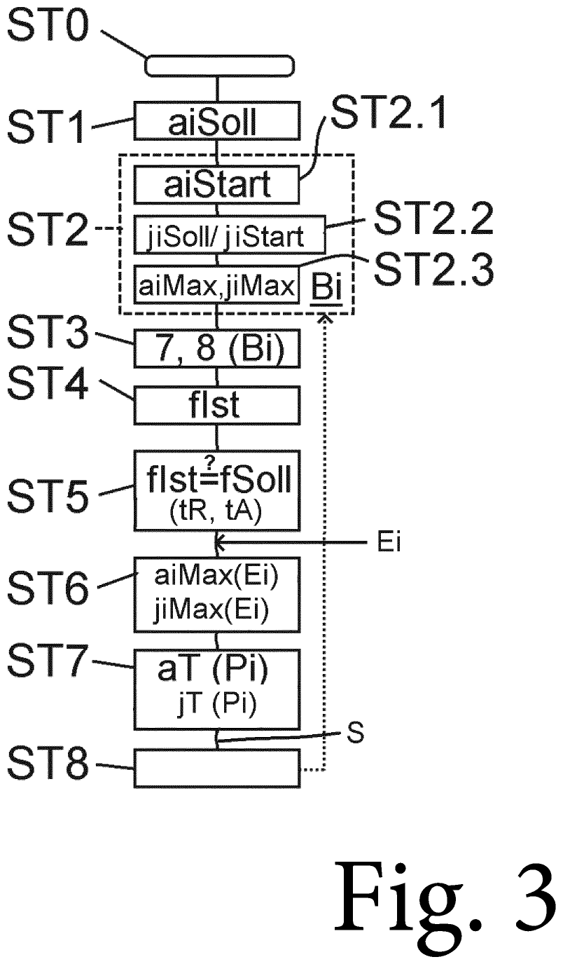

In this case, implementation of the emergency braking request zNSoll in each vehicle 2i normally takes place according to an AEBS cascade K (see FIGS. 2a, 2b), which contains a first warning phase K1 (optical (display) and/or acoustic (warning signal)), a haptic warning phase K2 and a final emergency braking phase K3, optimally with the specified emergency braking request zNSoll. This AEBS cascade K is advantageous in order to allow overriding, in particular by the driver of the leading vehicle 21 (lead vehicle X) of the vehicle group 1, in the event of incorrect detection (in the first warning phase K1) and to ensure a reaction time for the following traffic (haptic warning phase K2).

To improve the braking of the vehicles 2i of the vehicle group 1 in an emergency braking situation detected by the emergency braking system 12, provision can be made to adapt the AEBS cascade K as follows:

First, the actual distances dIstj between the vehicles 2i of the vehicle group 1 can be slowly increased by adapting the setpoint acceleration aiSoll already in the first warning phase K1 of the AEBS cascade K, e.g. in an energy- and wear-efficient manner by limiting or adapting the engine torques or the drag torques of the individual vehicles 2i. It is thereby possible to adapt the driving dynamics and thus to additionally escalate the situation with only a few active braking interventions. This slow increase in the actual distance dIstj causes a slow change in actual vehicle dynamics fIst of the individual vehicles 2i, this change being readily implementable by each of the vehicles 2i of the vehicle group 1.

In the haptic warning phase K2, according to FIG. 2a, from a haptic time tHi, continuous partial braking of at least some of the vehicles 2i of the vehicle group 1 takes place by specification of an intermediate acceleration aiZ, wherein the intermediate acceleration aiZ in the haptic warning phase K2 for the respective vehicle 2i is fixed at a haptic limit aiH, for example −4 m/s². The haptic braking phase K2 here serves to escalate the emergency braking situation and the driver warning, while at the same time the actual vehicle speed vi of the respective vehicle 2i is already being continuously reduced.

With increasing automation within the vehicle group 1, this escalation or driver warning within the vehicle group 1 is not or at least less relevant, and therefore the haptic warning phase K2 can be adapted in a vehicle-specific manner as follows:

As shown in FIG. 2a, the optical and/or acoustic warning for the leading vehicle 21 (lead vehicle X) is output to the driver of the leading vehicle 21 (lead vehicle X) as before in the first warning phase K1, in order to warn said driver. The haptic warning phase K2 with continuous partial braking can then take place at a later time than usual, as illustrated in FIG. 2a, or can be omitted altogether, as shown in FIG. 2b. In addition, for the lead vehicle 21, a haptic braking jerk R can take place, for example at an initial time tI1, which in particular replaces the haptic warning phase K2, omitted in FIG. 2b, with the continuous partial braking in order to warn the driver a second time.

As a result, the possibility of overriding by the human driver in the leading vehicle 21 (lead vehicle X) is still available since the driver receives a warning in the first warning phase K1. Continuous partial braking in the haptic warning phase K2 can be omitted for the lead vehicle X (see FIG. 2b) or can take place only very late (see FIG. 2a) since the following vehicles 2i of the vehicle group 1 coordinate with one another via the wireless data communication 9 and thus do not have to be made aware of imminent braking in this way. Thus, for the lead vehicle X, an escalation of the situation initially takes place with a very late or without a speed reduction. There can nevertheless be a warning via the haptic braking jerk R.

For the last vehicle 23 (tail vehicle Z) in the vehicle group 1, the normal AEBS cascade K (first warning phase K1, haptic warning phase K2 with a haptic limit aiH of, for example, −4 m/s² can take place at a specified haptic time tH3. As a result, there is both the possibility of override in the first warning phase K1 and the possibility of monitoring or a reaction time for the following traffic behind the last vehicle 23 of the vehicle group 1. The following traffic can accordingly adjust to and be prepared for (emergency) braking without wireless data communication with the vehicle group 1 since there is continuous partial braking with the haptic limit aiH in the haptic warning phase K2.

Within the framework of a coordinated strategy of all the vehicles 2i of the vehicle group 1, the haptic times tHi for initiating the haptic warning phase K2 of the respective vehicle 2i can be selected in accordance with a first specified functional relationship H1. This is defined in such a way, for example, that the haptic times tHi for the vehicles 2i between the lead vehicle X and the tail vehicle Z are uniformly distributed between the haptic time tH1 for the lead vehicle X and the haptic time tH3 for the tail vehicle Z.

If there is no haptic time tH1 for the lead vehicle X since no haptic warning phase K2 is provided for this (see FIG. 2b), an emergency braking time tN1, for example, is assumed as the haptic time tH1 for the lead vehicle X, at which time the lead vehicle X initiates the emergency braking phase K3.

The haptic warning phase K2 is followed by the emergency braking phase K3, in which the respective vehicle 2i, starting from the haptic limit aiH, insofar as the haptic warning phase K2 is carried out, is braked at a respectively assigned emergency braking time tNi in the direction of the (negative) setpoint acceleration aiSoll or the specified emergency braking request zNSoll. This takes place with a specified setpoint jerk jiSoll, which is preferably constant, and therefore there is a continuously rising braking ramp (see FIGS. 2a, 2b).

Here, the emergency braking time tNi is preferably identical for all the vehicles 2i for which a haptic warning phase K2 is present, as illustrated in FIGS. 2a and 2b. According to FIG. 2b, the lead vehicle X can already transition to the emergency braking phase K3 at an earlier emergency braking time tN without the vehicles 2i within the vehicle group 1 running into each other. Here, it is assumed that the lead vehicle X has built up a sufficiently large actual distance dIstl from the second vehicle 22 owing to the absence of a haptic warning phase K2 and thus the absence of braking with the haptic limit aiH. This has built up a distance reserve, which can be used by an earlier initiation of the emergency braking phase K3 for the lead vehicle X. Here, the emergency braking time tN1 and, if appropriate, also the setpoint j1Soll for the lead vehicle X can be selected, for example, as a function of the current actual distance dIstl between the lead vehicle X and the second vehicle 22 in order to take account of the distance reserve in the early initiation of the emergency braking phase K3 for the lead vehicle X.

In addition or as an alternative to the haptic times tHi, the setpoint jerks jiSoll for the respective vehicles 2i can also be defined in a vehicle-specific manner in accordance with a specified second functional relationship H2 in order to brake the vehicles 2i in the emergency braking phase K3 in a manner coordinated with one another in the vehicle group 1. This second functional relationship H2 is defined in such a way, for example, that the setpoint jerks jiSoll for the vehicles 2i between the lead vehicle X and the tail vehicle Z are uniformly distributed between the setpoint jerk j 1So11 for the lead vehicle X and the setpoint jerk j3Soll for the tail vehicle Z.

In particular, provision can also be made for the setpoint jerks jiSoll for the vehicles 2i following the lead vehicle X to be selected identically in the emergency braking phase K3 and only the haptic times tHi for the haptic warning phase K2 to be adapted as a function of the position Pi in accordance with the first functional relationship H1. Account is taken here of the fact that the respective vehicles 2i of the vehicle group 1 build up a distance reserve within the haptic warning phase K2 and can then be braked at a safe distance with the same setpoint jerks jiSoll in the context of emergency braking. As a result, there is already an expansion of the vehicle group 1 in the haptic warning phase K2.

Alternatively, it is possible for the same haptic times tHi to be selected for the initiation of the haptic warning phase K2 for all the vehicles 2i behind the lead vehicle X and for the setpoint jerks jiSoll to be defined in accordance with the second functional relationship H2 as a function of the position Pi. This also results in an expansion, which is accomplished by braking operations (jiSoll) of different power in the emergency braking phase K3.

As shown in FIG. 2a, however, a combination of both possibilities can also be provided. As a result, the vehicle group 1 is expanded both in the haptic warning phase K2 and in the emergency braking phase K3. The driver of the respective vehicle 2i is additionally prepared for the emergency braking, and escalation with a speed reduction to a correspondingly matched extent as a function of the position Pi in the vehicle group 1 is ensured. Here, the functional relationships H1, H2 can be linear as a function of the position Pi or else can follow some other specified function.

The setpoint acceleration aiSoll, also as emergency braking request zNSoll, can also be specified manually by the driver, for example by actuating an actuating element when a dangerous situation (emergency braking situation) or the like is detected, and can be implemented by means of the control unit 4 and communicated simultaneously to the other vehicles 2i of the vehicle group 1.

The control unit 4 can preferably also be designed to define vehicle-specific acceleration parameters Bi with which the drive system 7 and/or the braking system 8 of the respective vehicle 2i implements a specified setpoint acceleration aiSoll, in particular the emergency braking request zNSoll in the emergency braking phase K3 and/or the intermediate acceleration aiZ in the haptic warning phase K2, in the vehicle group 1 during a journey. In this case, the acceleration parameters Bi are preferably used in the implementation of any setpoint accelerations aiSoll (headway control system 5, control unit 4, driver assistance system 11, predictive emergency braking system 12 (zNSoll)), this being accomplished, for example, by means of corresponding transmission of the acceleration parameters Bi to the electronically controllable drive system 7 or braking system 8. The setpoint acceleration aiSoll, in particular the emergency braking request zNSoll or intermediate acceleration aiZ, can, however, in principle also be implemented in the haptic warning phase K2 and the emergency braking phase K3 without taking these acceleration parameters Bi into account.

As acceleration parameters Bi, a starting acceleration aiStart and/or a maximum acceleration aiMax and/or a starting jerk jiStart and/or a maximum jerk jiMax, for example, can be specified in a vehicle-specific way. This has the following effects on the AEBS cascade K (see FIG. 2c):

If a specific setpoint acceleration aiSoll or emergency braking request nZSoll is requested, the respective vehicle 2i is first accelerated negatively in the haptic warning phase K2 with an intermediate acceleration aiZ, which is defined by the specified starting acceleration aiStart. The haptic limit aiH is therefore overwritten, it also being possible to specify that the higher of the two values, i.e. aiStart or aiH, is used in the haptic warning phase K2. The starting acceleration aiStart (and also the haptic limit aiH) is normally smaller in terms of magnitude than the specified setpoint acceleration aiSoll, in particular the emergency braking request zNSoll, and has a value which any vehicle 2i is normally able to deliver.

Starting from this, the starting jerk jiStart indicates how the magnitude of the intermediate acceleration aiZ should be increased over time in the emergency braking phase K3, starting from the starting acceleration aiStart, in order to approximate the intermediate acceleration aiZ to the requested setpoint acceleration aiSoll or the emergency braking request zNSoll. Thus, the starting jerk jiStart is initially defined as a possible initial value for the setpoint jerk jiSoll, it also being possible for this subsequently to be adapted or for a different initial value to be defined.

The maximum acceleration aiMax indicates an additional limit, which the intermediate acceleration aiZ must not exceed in terms of magnitude, fundamentally both in the haptic warning phase K2 and in the emergency braking phase K3, it being assumed that the starting acceleration aiStart and also the haptic limit aiH are lower. However, the maximum acceleration aiMax may under certain circumstances be smaller in magnitude than the requested setpoint acceleration aiSoll, in particular the emergency braking request zNSoll, as shown for some vehicles in FIG. 2c.

The maximum jerk jiMax furthermore indicates a limit of the setpoint jerk jiSoll which must not be exceeded in terms of magnitude, particularly in the emergency braking phase K3. The maximum acceleration aiMax and/or the maximum jerk jiMax can follow, for example, from the maximum driving capacity AVMax or the maximum braking capacity BVMax which can be provided by the drive system 7 or the braking system 8 of the respective vehicle 2i. However, the maximum acceleration aiMax and/or the maximum jerk jiMax can also be specified for the control unit 4 of the respective vehicle 2i, for example via the V2X unit 10.

The starting acceleration aiStart and the starting jerk jiStart can also be specified to the control unit 4 by the V2X unit 10, whereupon the control unit 4 defines this in its own vehicle 2i in order to implement an existing setpoint acceleration aiSoll, taking into account the setpoint jerk jiSoll.

The definition of vehicle-specific acceleration parameters Bi allows selective coordination of the vehicles 2i of the vehicle group 1, this being explained in greater detail below with reference to FIGS. 2c and 3:

After initialization of the control units 4 in the vehicles 2i of the vehicle group 1 in an initial step STO (FIG. 3), for example when starting the vehicle 2i or when entering a vehicle group 1, an arbitrarily requested setpoint acceleration aiSoll for the respective vehicle 2i is detected or read in in a first step ST1.

In order to accelerate the entire vehicle group 1 safely in accordance with the setpoint acceleration aiSoll, positively or negatively, and to optimally coordinate the individual vehicles 2i with one another during this process within the scope of their performance capability, the vehicle-specific acceleration parameters Bi for each individual vehicle 2i are defined in a second step ST2. Definition takes place either centrally in one of the vehicles 2i of the vehicle group 1 with subsequent transmission to the individual vehicles 2i via the wireless data communication 9 or at least partially in a decentralized manner in each vehicle 2i separately, data signals S transmitted being taken into account.

In a first intermediate step ST2.1, a suitable starting acceleration aiStart, which it is assumed will be provided by each of the vehicles 2i of the vehicle group 1, is specified for this purpose. In a second intermediate step ST2.2, the starting jerk jiStart is defined as the initial value of the setpoint jerk jiSoll, provided that no other initial definition has been made, each vehicle 2i being assigned an individual starting jerk jiStart as the setpoint jerk jiSoll. In particular, the starting jerk jiStart is defined as a function of a position Pi of the respective vehicle 2i within the vehicle group 1.

In a third intermediate step ST2.3, the maximum acceleration aiMax and/or the maximum jerk jiMax is defined for the respective vehicle 2i, for example as a function of the maximum possible driving capacity AVMax or braking capacity BVMax of the respective vehicle 2i. If the maximum acceleration aiMax or the maximum jerk jiMax is not yet known at this time or cannot be determined, these are initially left undefined or fixed to a value of high magnitude, for example to the currently specified setpoint acceleration aiSoll.

As illustrated in FIG. 2c, the definition of the starting jerk jiStart as the setpoint jerk jiSoll takes place as a function of the position Pi of the respective vehicle 2i within the vehicle group 1 in such a way that the starting gradient jiStart

increases in terms of magnitude (i.e. also decreases) as the position Pi increases.

Accordingly, the third intermediate acceleration a3Z of the third vehicle 3 at the third position P3 is increased in magnitude along a steeper ramp (jiSoll, jiStart) than the first intermediate acceleration a1Z of the first vehicle 1 at the first position P1 when there is a requested reduction in the actual vehicle speed vi (aiSoll negative (zNSoll)).

This is based on the concept of accelerating or decelerating a vehicle 2i traveling further to the rear within the vehicle group 1 in a more strongly negative manner than a vehicle 2i traveling further to the front in order to prevent a collision of the vehicles 2i in the respective driving situation. This is achieved precisely by virtue of the fact that, starting from the starting acceleration aiStart, the vehicle 2i traveling further to the rear reduces its intermediate acceleration aiZ to a greater extent than the vehicle or vehicles 2i traveling in front of it.

According to the exemplary embodiment shown in FIG. 2c, starting from the starting acceleration aiStart, the intermediate acceleration aiZ is increased or reduced for all the vehicles 2i at a common emergency braking time tN1, tN2, tN3 with different values for the setpoint jerk jiSoll. As already described for FIGS. 2a and 2b, however, this can also be adapted.

As an alternative or in addition to such a definition of different values for the setpoint jerk jiSoll as a function of the position Pi of the respective vehicle 2i, it is also possible in principle for the emergency braking times tNi at which, starting from the starting acceleration aiStart (or the haptic limit aiH), the respective vehicle 2i adapts its intermediate acceleration aiZ with the setpoint jerk jiSoll to vary as a function of the position Pi. Accordingly, the third vehicle 23 can, for example, enter the emergency braking phase K3 earlier than the other two vehicles 21, 22. This too ensures that vehicles 2i of the vehicle group 1 which are traveling one behind the other are braked continuously with different intermediate accelerations aiZ and thus cannot run into one another. Preferably, however, the selection of different starting jerks jiStart or setpoint jerks jiSoll as a function of the position Pi and a simultaneous increase in the intermediate acceleration aiZ is provided for each vehicle 2i in order to shorten the period of time to achieve the requested setpoint acceleration aiSoll for the entire vehicle group 1, this being decisive particularly in emergency braking situations.

In a third step ST3, the previously defined acceleration parameters Bi are used directly or indirectly to implement the setpoint acceleration aiSoll specified in the first step ST1, taking into account the setpoint jerk jiSoll, via the drive system 7 or the braking system 8 of the respective vehicle 2i. Rules are thus imposed on the respective vehicle 2i as to how it must implement a specified setpoint acceleration aiSoll.

In a fourth step ST4, the driving-dynamics behavior (actual driving dynamics fIst) of the vehicles 2i of the vehicle group 1 is observed during implementation of the setpoint acceleration aiSoll using the acceleration parameters Bi and taking into account the setpoint jerk jiSoll. This can be accomplished, for example, in that an actual acceleration aiIst present and/or the actual vehicle speed vi and/or an actual jerk jiIst of the respective vehicle 2i of the respective vehicle 2i are determined. This observation can take place in a decentralized manner in each of the vehicles 2i or else centrally in one of the vehicles 2i in that the actual acceleration aiIst and/or the actual vehicle speed vi is transmitted wirelessly between the vehicles 2i in a time-resolved manner via the data signals S.

Alternatively, it is also possible to consider the actual distance dIstj between the individual vehicles 2i and/or an actual distance change dAIstj in a time-resolved manner in order to observe the actual driving dynamics fIst of a vehicle 2i. Accordingly, it can be determined, for example by means of sensors, how quickly two vehicles 2i are approaching one another or moving further apart.

In a fifth step ST5, the observed actual driving dynamics fIst (aiIst, vi, dIstj, dAIstj, jiIst) are compared with setpoint driving dynamics fSoll, wherein the setpoint driving dynamics fSoll are indicated by the setpoint acceleration aiSoll, taking into account the setpoint jerk jiSoll and the acceleration parameters Bi. Depending on this comparison, a vehicle-specific assessment result Ei is output, which indicates whether the respective vehicle 2i is capable of adapting the intermediate acceleration aiZ, taking into account the setpoint jerk jiSoll and the acceleration parameters Bi, and of achieving the setpoint acceleration aiSoll in this way.

If, for a vehicle 2i of the vehicle group 1, it is determined, for example, that

the actual acceleration aiIst does not increase further in magnitude and at the same time the setpoint acceleration aiSoll has not yet been reached, or

the actual acceleration aiIst decreases in magnitude within a specified period of time tR, wherein the specified period of time (tR) is dependent on the setpoint jerk (jiSoll), taking into account a response time tA, or

the actual distance dIstj does not behave in accordance with the specified setpoint driving dynamics fSoll of the two vehicles 2i driving at the actual distance dIstj, or the actual distance change dAIstj does not correspond to the expected behavior (decrease or increase),

an assessment result Ei is output for the respective vehicle 2i, which indicates whether the respective vehicle 2i is not capable of adapting the intermediate acceleration aiZ, taking into account the setpoint jerk jiSoll and the acceleration parameters Bi, and of achieving the setpoint acceleration aiSoll in this way.

Thereupon, in a sixth step ST6, the currently present actual acceleration aiIst is defined as the maximum acceleration aiMax and/or the present actual jerk jiIst is defined as the maximum jerk jiMax for the respective vehicle 2i. The value assumed temporarily in the third intermediate step 2.3 for the maximum acceleration aiMax and/or the maximum jerk jiMax is thereby confirmed, overwritten or supplemented. This maximum acceleration aiMax or this maximum jerk jiMax is then transmitted in a seventh step ST7 as an acceleration limit value aT or jerk limit value jT, via the data signal S, to the other vehicles 2i of the vehicle group 1. In this case, the respective vehicle 2i or its position Pi can also be assigned to the acceleration limit value aT or the jerk limit value jT in the data signal S.

In an eighth step ST8, the transmitted acceleration limit value aT or the jerk limit value jT is used as the acceleration parameter Bi or as the maximum acceleration aiMax or maximum jerk jiMax for the other vehicles 2i of the vehicle group 1. Thus, the maximum accelerations aiMax or maximum jerks jiMax of all the vehicles 2i of the vehicle group 1 are uniformly set to the previously determined acceleration limit value aT or jerk limit value j T. Alternatively, provision can also be made for the transmitted acceleration limit value aT or jerk limit value jT to be used as the maximum acceleration aiMax or maximum jerk jiMax only in the case of the vehicles 2i which, in the case of a negative setpoint acceleration aiSoll, in particular of the emergency braking request zNSoll, are traveling in front of the vehicle 2i associated with the acceleration limit value aT or jerk limit value jT. For this purpose, it is possible to take into account the position Pi of the respective vehicle 2i which is associated with the acceleration limit value aT or jerk limit value j T.

In this way, it is possible, when adapting the respective intermediate acceleration aiZ in accordance with the setpoint jerk jiSoll, to determine successively for each vehicle 2i which maximum acceleration aiMax or which maximum jerk jiMax is relevant and whether the driving dynamics of the further vehicles 2i of the vehicle group 1 must be adapted thereto in order to avoid the vehicles 2i running into one another in the respective driving situation, in particular in the emergency braking phase K3.

This is illustrated by way of example in FIG. 2c. According to this, in the emergency braking phase K3, the requested setpoint acceleration aiSoll is achieved for the third vehicle 23 at the third position P3 of the vehicle group 1, wherein the maximum acceleration aiMax for the third vehicle 3 either corresponds to the setpoint acceleration aiSoll or this acceleration has not yet been achieved. For the second vehicle 22, the intermediate acceleration aiZ reaches the second maximum acceleration a2Max in the emergency braking phase K3 from a specific time, for example because the maximum braking capacity BVMax for the second vehicle 22 has been reached. In this case, the second maximum acceleration a2Max is lower than the requested setpoint acceleration a2Soll (corresponds to zNSoll). This also has effects on the first vehicle 21 at the first position P1, which accordingly also has to be braked at the maximum with the second maximum acceleration a2Max to avoid the second vehicle 22 running into the first vehicle 21. Accordingly, the second maximum acceleration a2Max is transmitted as an acceleration limit value aT assigned to the second vehicle 22 (second position P2) via the wireless data communication, in particular to the first vehicle 21. In this vehicle, the acceleration limit value aT is used as one of the acceleration parameters B1 to define the first maximum acceleration aIMax, and therefore the first vehicle 21 too brakes at the maximum with the first or second maximum acceleration a1Max(=a2Max) in the emergency braking phase K3. Since the implemented acceleration of the first vehicle 21 follows the implemented acceleration of the second vehicle 22 in time during the braking process, it is possible, by means of real-time transmission of the second maximum acceleration a2Max of the second vehicle 22 which has just been determined, to ensure that the first vehicle 21 reacts to the limitation of the second vehicle 22 which has just been achieved, that is to say a2Max, while the braking process is still taking place. It is by just such means that improved accident prevention within the vehicle group 1 can be achieved.

With this described method sequence, it is therefore possible to accomplish optimized and uniform definition of the maximum accelerations aiMax over the entire vehicle group 1, thus making it possible to avoid the individual vehicles 2i within the vehicle group 1 running into one another in the respective driving situation. While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS (PART OF THE DESCRIPTION)

1 vehicle group (platoon)

2i i-th vehicle of the vehicle group

4 control unit

5 headway control system

6 internal environment detection system

7 drive system

8 braking system

9 wireless data communication (V2X)

10 V2X unit

11 driver assistance system

12 predictive emergency braking system (AEBS)

aiIst actual acceleration

aiMax maximum acceleration

aiHhaptic limit

aiSo11 setpoint acceleration

aiStart starting acceleration

aiZ intermediate acceleration

aINcentral acceleration request

aT acceleration limit value

AVMax maximum driving capacity

Bi vehicle-specific acceleration parameters

BVMax maximum braking capacity

dIstj actual following distance

dAIstj actual following distance change

dSollj setpoint following distance

Ei assessment result

fIst actual driving dynamics

fSoll setpoint driving dynamics

H1 first functional relationship for tHi

H2 second functional relationship for jiSoll

jiIst actual jerk

jiMax maximum jerk

jiSoll setpoint jerk

jiStart starting jerk

jiT jerk limit value

K AEBS cascade

K1 warning phase

K2 haptic warning phase

K3 emergency braking phase

Pi position of the i-th vehicle 2i in the vehicle group 1

R haptic braking jerk

S data signal

tZ time

tI initial time

tA response time

tHi haptic times

tNi emergency braking times

tR period of time

vi actual vehicle speed

X lead vehicle

Y following vehicle

Z tail vehicle

zNSoll emergency braking request

ST0, ST1, ST2, ST2.1, ST2.2, ST2.3, ST3, ST4, ST5, ST6, ST7, ST8

1. A method for coordinating vehicles of a vehicle group, wherein the vehicles each have an electronically controllable braking system, the method comprising:
implementing a requested setpoint acceleration, taking into account a setpoint jerk, via the electronically controllable braking system, wherein the setpoint acceleration for each vehicle is specified as a function of an emergency braking request triggered manually or automatically;
assigning a position in the vehicle group to each vehicle;
implementing the emergency braking request;
providing, in order to implement the emergency braking request in a respective vehicle of the vehicle group, in an advanced emergency braking system (AEBS) cascade, at least:
a first warning phase for an optical or acoustic warning of a driver of the respective vehicle-of the vehicle group, and
an emergency braking phase for braking the respective vehicle of the vehicle group as a function of the emergency braking request, taking into account the setpoint jerk, at an emergency braking time; and
providing a haptic warning phase for at least one vehicle of the vehicle group at a haptic time within a framework of the AEBS cascade, wherein in the haptic warning phase, the respective vehicle is decelerated continuously with a defined intermediate acceleration which is less than a haptic limit of the emergency braking request,
wherein the haptic time for initiating the haptic warning phase or the setpoint jerk for implementing the emergency braking request in the emergency braking phase is defined in a vehicle-specific manner.

2. The method as claimed in claim 1, wherein the haptic time for initiating the haptic warning phase with continuous braking intervention can be delayed at least for a leading lead vehicle of the vehicle group up to the emergency braking time for initiating the emergency braking phase for the leading lead vehicle of the vehicle group.

3. The method as claimed in claim 1, wherein the haptic time for initiating the haptic warning phase of the respective vehicle or the setpoint jerk for implementing the emergency braking request in the emergency braking phase of the respective vehicle is defined as a function of the position of the respective vehicle within the vehicle group.

4. The method as claimed in claim 3, wherein the haptic time for initiating the haptic warning phase decreases as the position in the vehicle group increases, or the setpoint jerk for implementing the emergency braking request in the emergency braking phase of the respective vehicle decreases as the position increases.

5. The method as claimed in claim 3, wherein the setpoint jerk for implementing the emergency braking request in the emergency braking phase of the respective vehicle or the emergency braking time defined as a function of an actual following distance between vehicles of the vehicle group.

6. The method as claimed in claim 1, wherein the emergency braking time for the respective vehicle is defined as a function of the haptic time and/or the position of the respective vehicle within the vehicle group.

7. The method as claimed in claim 1, comprising carrying out, in the first warning phase, energy-efficient and wear-efficient adaptation of an actual distance between vehicles of the vehicle group by electric control of a drive system of the respective vehicle in order to limit or adapt an output engine torque.

8. The method as claimed in claim 1, comprising generating, after the first warning phase and before the emergency braking phase, a haptic braking jerk in the respective vehicle at an initial time, wherein the initial time is dependent on the haptic time for initiating the haptic warning phase or dependent on the presence of the haptic warning phase.

9. The method as claimed in claim 1, comprising:
implementing the emergency braking request in each vehicle of the vehicle group by electric control of the braking system of each vehicle, taking into account the setpoint jerk and specified vehicle-specific acceleration parameters, wherein the acceleration parameters define how the requested emergency braking request is implemented;
observing actual driving dynamics of the vehicles of the vehicle group during the implementation of the emergency braking request, taking into account the setpoint jerk and the vehicle-specific acceleration parameters;
assessing the observed actual driving dynamics of the vehicles on the basis of the requested setpoint acceleration for the respective vehicle, taking into account the setpoint jerk and the vehicle-specific acceleration parameters;
outputting a vehicle-specific assessment result; and
determining and outputting an acceleration limit value or a jerk limit value as a function of the vehicle-specific assessment result and adapting the vehicle-specific acceleration parameters in at least one of the vehicles of the vehicle group as a function of the determined acceleration limit value or jerk limit value in order to implement the emergency braking request, taking into account the adapted vehicle-specific acceleration parameters.

10. The method as claimed in claim 9, wherein the assessment of the observed actual driving dynamics includes a comparison of the actual driving dynamics with setpoint driving dynamics for the respective vehicle in order to determine whether the respective vehicle is capable of achieving the setpoint driving dynamics, wherein the setpoint driving dynamics are preferably indicated by the emergency braking request, taking into account the setpoint jerk and the acceleration parameters.

11. The method as claimed in claim 9, comprising specifying a starting acceleration for defining an initial intermediate acceleration of the respective vehicle in the haptic warning phase or a starting jerk for adapting the intermediate acceleration in the direction of the requested emergency braking request in the emergency braking phase as the vehicle-specific acceleration parameter in order to implement the requested emergency braking request, taking into account the acceleration parameters.

12. The method as claimed in claim 9, comprising defining a maximum acceleration or a maximum jerk as the acceleration parameter for limiting a currently requested intermediate acceleration or the setpoint jerk, at least when implementing the requested emergency braking request, taking into account the vehicle-specific acceleration parameters in the emergency braking phase.

13. The method as claimed in claim 12, wherein the maximum acceleration is a function of the determined acceleration limit value and/or the maximum jerk is a function of the jerk limit value.

14. The method as claimed in claim 13, wherein the maximum acceleration is a function of the determined acceleration limit value or the maximum jerk is a function of the determined jerk limit value only for vehicles of the vehicle group which, when the emergency braking request is specified, are traveling ahead of the vehicle assigned to the acceleration limit value or the jerk limit value.

15. The method as claimed in claim 12, wherein the maximum acceleration or the maximum jerk of a vehicle is defined or adapted as a function of a maximum driving capacity or of a maximum braking capacity of one of the vehicles in the vehicle group.

16. The method as claimed in claim 11, wherein the starting jerk of the respective vehicle is defined as a function of the position of the vehicle within the vehicle group, wherein the starting jerk of the respective vehicle decreases as the position within the vehicle group increases, and wherein the position of the first vehicle of the vehicle group is lower than the position of the last vehicle of the vehicle group.

17. The method as claimed in claim 9, wherein observing the actual driving dynamics includes observing with respect to time of an actual vehicle speed of the respective vehicle or an actual acceleration of the respective vehicle or an actual jerk of the respective vehicle, taking into account a response time or an actual distance between two vehicles of the vehicle group or an actual distance change of the actual distance between two vehicles of the vehicle group.

18. The method as claimed in claim 17, wherein the vehicle-specific assessment result is formed as a function of whether
the actual vehicle speed of the respective vehicle remains constant, or
the actual acceleration of the respective vehicle remains constant or decreases in magnitude within a specified period of time, wherein the specified period of time is dependent on the setpoint jerk, taking into account the response time, or
the actual distance between two vehicles remains constant or decreases, or
the actual distance change is less than or equal to zero.

19. The method as claimed in claim 9, wherein the setpoint acceleration or the setpoint jerk or the vehicle-specific acceleration parameters for the respective vehicle is/are defined in a decentralized manner in the respective vehicles, as a function of data signals transmitted wirelessly between the vehicles, or centrally in one of the vehicles.

20. The method as claimed in claim 9, comprising checking, during the implementation of the emergency braking request taking into account the setpoint jerk and the vehicle-specific acceleration parameters, a check is made to determine whether the actual distance between the individual vehicles of the vehicle group falls below a specified setpoint distance for the respective vehicles.

21. A control unit for a vehicle which is located in a vehicle group for carrying out a method as claimed claim 1, wherein the control unit is designed to implement the emergency braking request as the setpoint acceleration in the respective vehicle of the vehicle group by electric control of the braking system of the respective vehicle, wherein the setpoint acceleration for the respective vehicle can be specified as a function of an emergency braking request triggered manually or automatically,
wherein the control unit, in an AEBS cascade, is configured to:
request an optical or acoustic warning to the driver of the respective vehicle of the vehicle group in a first warning phase, and
implement braking of the respective vehicle of the vehicle group as a function of the emergency braking request in an emergency braking phase, taking into account the setpoint jerk, at an emergency braking time,
wherein the control unit is configured to implement a haptic warning phase for at least one vehicle of the vehicle group at a haptic time within the framework of the AEBS cascade, in which phase the respective vehicle can be decelerated continuously with a defined intermediate acceleration, which is less than the emergency braking request, and
wherein the control unit is designed to define the haptic time for initiating the haptic warning phase and/or the setpoint jerk for implementing the emergency braking request in the emergency braking phase in a vehicle-specific manner.

22. A vehicle having a control unit as claimed in claim 21.
